(19) United States
(12) Patent Application Publication
(10) Pub. No.: US 2021/0129979 A1
(43) Pub. Date: May 6, 2021

(54) FOLDABLE AND RETRACTABLE MECHANISM, PROPELLER PROTECTION DEVICE, AND ROTOR UNMANNED AERIAL VEHICLE

(71) Applicant: SZ DJI TECHNOLOGY CO., LTD., Shenzhen (CN)

(72) Inventors: Chaorui WANG, Shenzhen (CN); Rongming XIONG, Shenzhen (CN)

(21) Appl. No.: 17/144,430

(22) Filed: Jan. 8, 2021

Related U.S. Application Data
(63) Continuation of application No. PCT/CN2018/095249, filed on Jul. 11, 2018.

(51) Int. Cl. B64C 27/20; B64C 11/00; B64C 39/02

(52) U.S. Cl. CPC B64C 27/20; B64C 11/001; B64C 2201/108; B64C 2201/027; B64C 39/024

(57) ABSTRACT

A foldable and retractable mechanism includes a first body and a second body. The first body includes a first connection member. The second body is configured to rotate relative to the first body and including a second connection member. The first connection member and the second connection member are assembled in movable manner. The first connection member and the second connection member are configured to be in a retracted state, in which the first connection member and the second connection member at least partially overlap with each other and constraint relative rotation of the first body and the second body. The first connection member and the second connection member are configured to be in an extended state, in which the first connection member is away from the second connection member, and the second body is rotatable and capable of being folded over the first body.

### CROSS-REFERENCE TO RELATED APPLICATION

This application is a continuation of International Application No. PCT/CN2018/095249, filed Jul. 11, 2018, the entire content of which is incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to a foldable and retractable mechanism, a propeller protection device, and a rotor unmanned aerial vehicle.

### BACKGROUND

When an unmanned aerial vehicle (UAV) carries, transports, and flies, propellers of the UAV are easily damaged. Thus, a propeller protection device needs to be mounted at the propellers to protect the propellers. A related propeller protection cover may be foldable, however, when being unfolded and applied, a connection part of the propeller protection cover has a weak structure strength and are easily damaged by hitting.

### SUMMARY

Embodiments of the present disclosure provide a foldable and retractable mechanism including a first body and a second body. The first body includes a first connection member. The second body is configured to rotate relative to the first body and including a second connection member. The first connection member and the second connection member are assembled in movable manner. The first connection member and the second connection member are configured to be in a retracted state, in which the first connection member and the second connection member at least partially overlap with each other and constraint relative rotation of the first body and the second body. The first connection member and the second connection member are configured to be in an extended state, in which the first connection member is away from the second connection member, and the second body is rotatable and capable of being folded over the first body.

Embodiments of the present disclosure provide a propeller protection device including a foldable and retractable mechanism. The mechanism includes a first propeller cover and a second propeller cover. The first propeller cover includes a first connection member. The second body is configured to rotate relative to the first body and includes a second connection member. The first connection member and the second connection member are assembled in movable manner. The first connection member and the second connection member are configured to be in a retracted state, in which the first connection member and the second connection member at least partially overlap with each other and constraint relative rotation of the first propeller cover and the second propeller cover. The first connection member and the second connection member are configured to be in an extended state, in which the first connection member is away from the second connection member, and the second propeller cover is rotatable and capable of being folded over the first propeller cover.

### BRIEF DESCRIPTION OF THE DRAWINGS

FIG. 1 is a schematic structural diagram of a rotor unmanned aerial vehicle (UAV) according to some embodiments of the present disclosure.

FIG. 2 is a schematic exploded structural diagram showing a propeller protection device according to some embodiments of the present disclosure.

FIG. 3 and FIG. 4 are schematic partial structural diagrams showing the propeller protection device from different view angles according to some embodiments of the present disclosure.

FIG. 5 is a schematic structural diagram showing the propeller protection device in a retracted state according to some embodiments of the present disclosure.

FIG. 6 and FIG. 7 are schematic partial cross-sectional diagrams showing the propeller protection device in the retracted state according to some embodiments of the present disclosure.

FIG. 8 is a schematic partial cross-sectional diagram showing a rotatable connector and a first connection member of the propeller protection device in the retracted state according to some embodiments of the present disclosure.

FIG. 9 is a schematic partial cross-sectional diagram showing the rotatable connector and the first connection member of the propeller protection device in an extended state according to some embodiments of the present disclosure.

FIG. 10 is a schematic cross-sectional diagram showing the propeller protection device in the extended state and folded according to some embodiments of the present disclosure.

FIG. 11 is a schematic perspective diagram showing the propeller protection device in the extended state and folded according to some embodiments of the present disclosure.

FIG. 12 is a schematic partial structural diagram showing the propeller protection device in the retracted state according to some embodiments of the present disclosure.

FIG. 13 is a schematic partial structural diagram showing the propeller protection device in the extended state and unfolded according to some embodiments of the present disclosure.

### DETAILED DESCRIPTION OF THE EMBODIMENTS

The technical solutions of embodiments of the present disclosure are described in detail in connection with the accompanying drawings of embodiments of the present disclosure. Described embodiments are merely some embodiments, but not all embodiments. Based on embodiments of the present disclosure, all other embodiments made by those of ordinary skill in the art without creative efforts are within the scope of the present disclosure.

Exemplary embodiments are described in detail here, and their examples are represented in the accompanying drawings. When the following description relates to the accompanying drawings, unless otherwise specified, same numbers in different drawings indicate same or similar elements. Implementations described in exemplary embodiments do not represent all implementations consistent with the present disclosure. On the contrary, they are merely examples of devices and methods described in detail in the appended claims and consistent with some aspects of the present invention.

The terms used in the present disclosure are only for the purpose of describing specific embodiments and are not intended to limit the present disclosure. The singular forms “a,” “the said,” and “the” used in the present disclosure and the appended claims are also intended to include plural forms unless the context clearly indicates other meanings. The term “and/or” as used herein refers to and includes any or all possible combinations of one or more associated listed items.

Embodiments of the present disclosure are described in detail in connection with the accompanying drawings as follows. When there is no conflict, features of embodiments and implementations may be combined with each other.

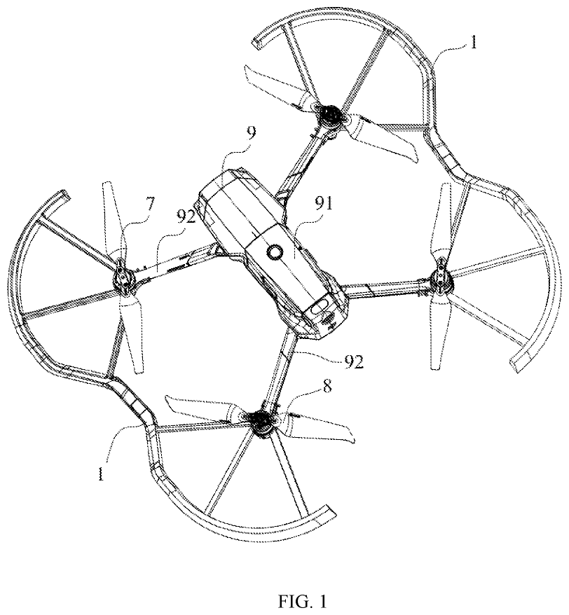

As shown in FIG. 1, a rotor unmanned aerial vehicle (UAV) of embodiments of the present disclosure includes a vehicle body 9, a first propeller 7 and a second propeller 8 connected to the vehicle body 9, and a propeller protection device 1. The vehicle body 9 includes a body 91 and a vehicle arm 92. The vehicle arm 92 is connected to the body 91. A first propeller 7 and a second propeller 8 are connected to neighboring vehicle arms 92. The propeller protection device 1 is connected to the first propeller 7 and the second propeller 8.

The rotor UAV includes a four-rotor UAV as shown in FIG. 1, or may include, e.g. a six-rotor UAV, an eight-rotor UAV, etc., which is not limited. Correspondingly, a number of the propellers may be determined according to a specific condition of the rotor UAV. The first propeller and the second propeller may include neighboring propellers of the rotor UAV.

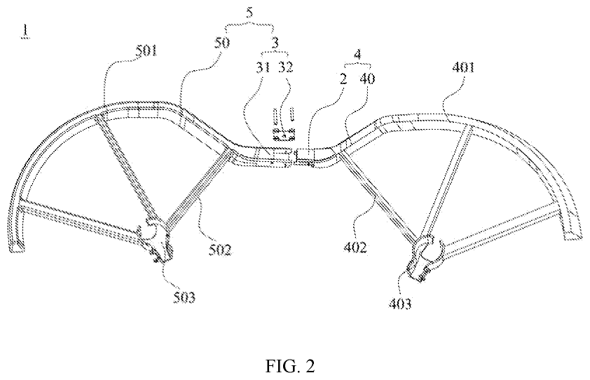

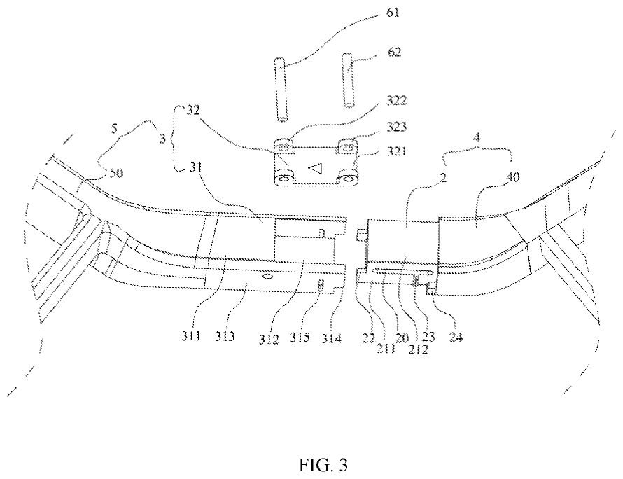

As shown in FIG. 2 and FIG. 3, the propeller protection device 1 includes a foldable and retractable mechanism. The foldable and retractable mechanism includes a first body 4 and a second body 5. When the foldable and retractable mechanism is applied in the propeller protection device 1, the first body 4 may include a first propeller protection cover, and the second body 5 may include a second propeller protection cover. The first propeller protection cover and the second propeller protection cover may form a foldable and retractable connection. The first propeller protection cover may be connected to the first propeller 7, and the second propeller protection cover may be connected to the second propeller 8 to protect the first propeller 7 and the second propeller 8.

In some embodiments, for example, the foldable and retractable mechanism applied in the propeller protection device 1 is further described as follows. In some other embodiments, the foldable and retractable mechanism may be applied in another device to realize a foldable and retractable connection between a first body and a second body of the device, which is not limited.

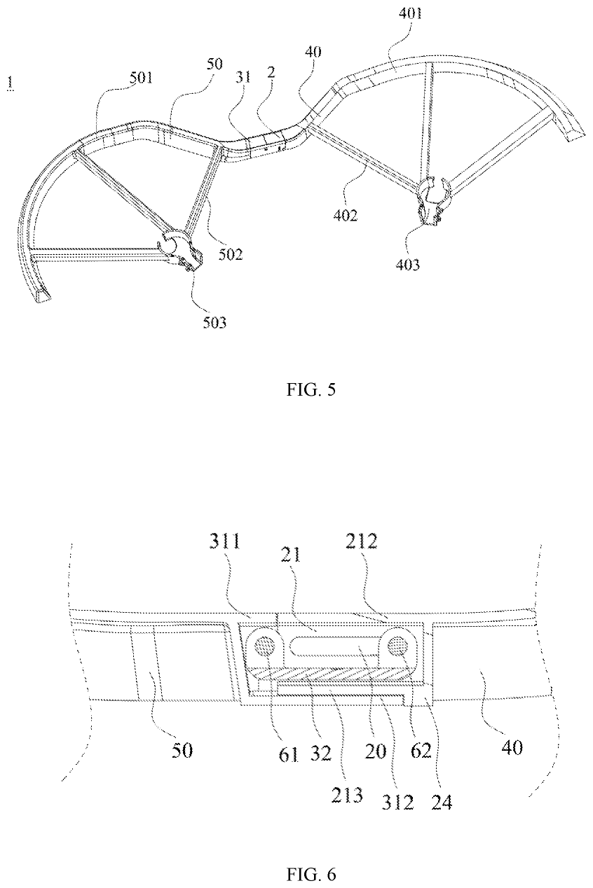

As shown in FIG. 3 to FIG. 5, the first body 4 includes a first base 40 and a first connection member 2. The first connection member 2 may be formed integrally at the first base 40 to ensure the strength of the first body 4. In some other embodiments, the first connection member 2 may be connected to the first base 40 by an external connector.

The second body 5 includes a second base 50 and a second connection member 3. The second base 50 is connected to the second connection member 3.

The first base 40 and the second base 50 may form a symmetrical structure. The first base 40 includes a first curved member 401, a first beam 402, and a first center connection member 403. The second base 50 includes a second curved member 501, a second beam 502, and a second center connection member 503. The first curved member 401 and the second curved member 501 may form a foldable and retractable connection through the first connection member 2 and the second connection member 3. Take the first base 40 as an example, the first curved member 401 is connected to the first center connection member 403 through the first beam 402. The first center connection member 403 may be connected to a propeller base of the first propeller 7 to realize a connection between the first body 4 and the first propeller 7. The number of the first beam 402 is not limited and may be, for example, three.

Specific forms of the first base 40 and the second base 50 are not limited here. For example, the first base 40 may have a structural form of a connected ring shape member and connection arm, and the second base 50 may have the same structural form. The foldable and retractable connection may be realized by arranging the first connection member 2 at the connection arm of the first base 40 and the second connection member 3 at the connection arm of the second base 50.

The second connection member 3 includes a connection body 31 and a rotatable connector 32.

The connection body 31 may be fixed at the second base 50. To fix the connection body 31 at the second base 50, the connection body 31 may be formed integrally at the second base 50 or may be fixed at the second base 50 by other manners, such as by a screw locking manner.

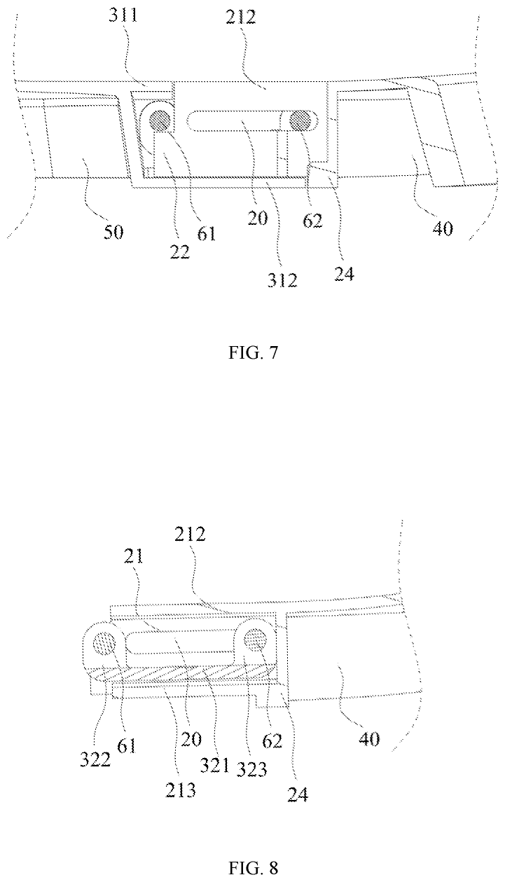

As shown in FIG. 3, FIG. 8, and FIG. 9, the rotatable connector 32 includes a plate member 321 and a protrusion member. The protrusion member includes at least two first lugs 322 and at least two second lugs 323. The first lugs 322 are arranged at the plate member 321 and along a straight line. A first shaft 61 passes through the first lugs 322. The second lugs 323 are arranged at the plate member 321 and along a straight line. A second shaft 62 passes through the second lugs 323. The first lugs 322 and the second lugs 323 are arranged symmetrically on two sides of the plate member 321 to cause the rotatable connector 32 to be seen as a U shape from the side and front.

The protrusion member protrudes from an upper surface of the plate member 321 upward to cause axes of the first shaft 61 and the second shaft 62 to be higher than the plate member 321. The protrusion member raises the first shaft 61 and the second shaft 62 to be higher than the surface of the plate member 321 to increase a rotatable angle of the rotatable connector 32 relative to the first connection member 2 and a rotatable angle of the rotatable connector 32 relative to the connection body 31 at a certain degree. When rotating to a certain angle, the plate member 321 may provide a certain resistant function.

As shown in FIG. 3, FIG. 6, and FIG. 7, the connection body 31 includes a corresponding shaft hole. A middle portion of the first shaft 61 is inserted in and connected to the protrusion member of the rotatable connector 32. An end of the first shaft 61 is inserted in and connected to the shaft hole of the connection body 31. As such, the rotatable connector 32 may rotate relative to the connection body 31, such that the connection body 31 may drive the second base 50 to rotate relative to the rotatable connector 32.

The first connection member 2 includes two first sidewalls 211 connected to the first base 40. A first upper wall 212 is arranged above the two first sidewalls 211. The first upper wall 212 may not be arranged above the two first sidewalls 211. Thus, an upper side of the two first sidewalls 211 may be opened to reserve a certain folding space for the rotatable connector 32.

A guide member 20 is arranged at the first sidewall 211. The guide member 20 may include a straight-line slide slot. In some other embodiments, the guide member 20 may include a straight-line track, which is not limited here.

A middle portion of the second shaft 62 is inserted in and connected to the protrusion member of the rotatable connector 32. An end of the second shaft 62 is inserted into and connected to the straight-line slide slot. As such, the rotatable connector 32 may slide along the straight-line slide slot relative to the first connection member 2 to cause the second connection member 3 to move relative to the first connection member 2. An axial direction of the second shaft 62 is perpendicular to the sliding direction (a length direction of the straight-line slide slot). When sliding to an end of the straight-line slide slot, the rotatable connector 32 may rotate relative to the first connection member 2 to be close to the two first sidewalls 211 of the first connection member 2 to be folded.

When the guide member 20 includes another shape, for example, a curved slide slot, the shape of the rotatable connector 32 may be adaptively adjusted to ensure the rotatable connector 32 to move back and forth along the guide member 20 and rotate.

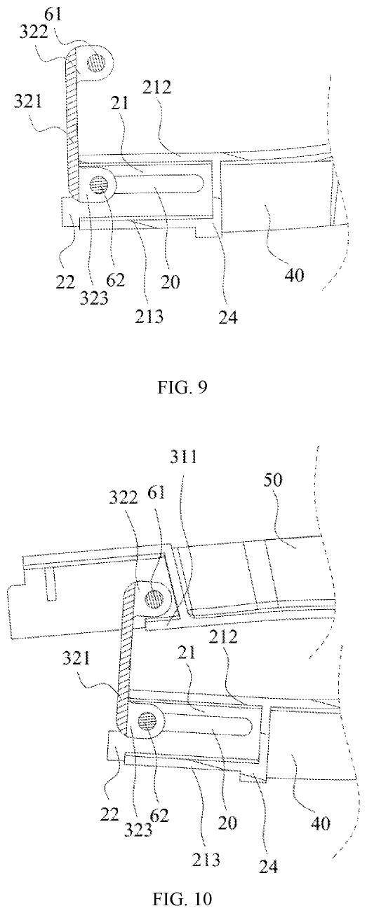

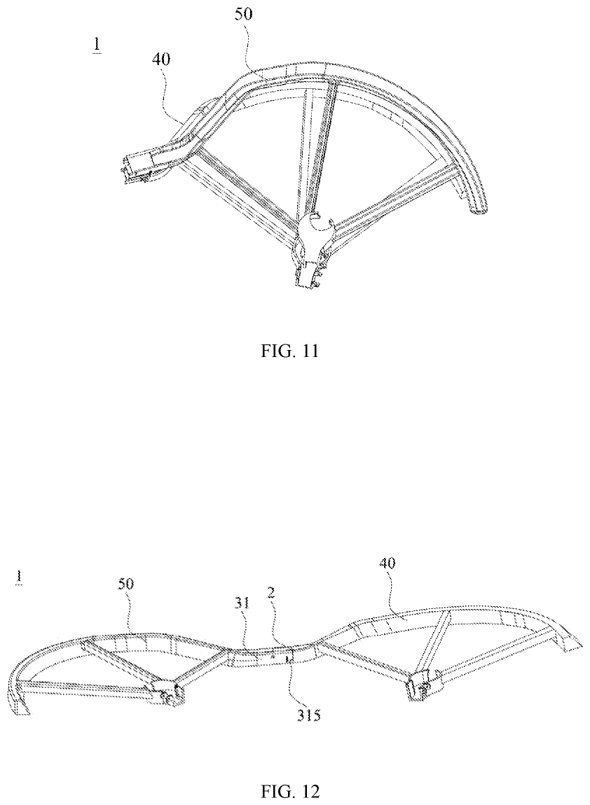

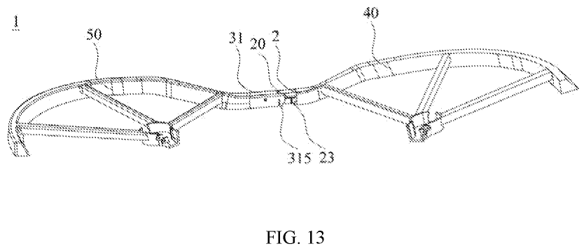

The rotatable connector 32 may drive the connection body 31 and the second base 50 to move to cause the first connection member 2 to be away from the second connection member 3. When the connection body 31 and the second base 50 move to a position where the second connection member 3 and first connection member 2 are in the extended state (as shown in FIG. 13), the rotatable connector 32 may rotate relative to the guide member 20 through the second shaft 62. Thus, As shown in FIG. 9, the second connection member 3 and the first connection member 2 may rotate relatively, that is, the second body 5 and the first body 4 may be relatively rotatable. Further, as shown in FIG. 10 and FIG. 11, the connection body 31 may rotate relative to the rotatable connector 32 via the first shaft 61, thus, the second body 5 and the first body 4 may be foldable.

The first connection member 2 being away from the second connection member 3 is relative. The first connection member 2 is further away from the second connection member 3 in the extended state, and the first connection member 2 is closer to the second connection member 3 in the retracted state.

The rotatable connector 32 may drive the connection body 31 and the second base 50 to move to cause the first connection member 2 to be close to the second connection member 3, as shown in FIG. 6, to cause the second connection member 3 and the first connection member 2 to be in the retracted state. In this state, the rotatable connector 32 may at least partially overlap with the connection body 31. The relative rotation between the rotatable connector 32 and the connection body 31, the relative rotation between the rotatable connector 32 and the first connection member 2 may be restricted. That is, in the retracted state, the relative rotation of the first connection member 2 and the second connection member 3 may be restricted, and the second body 5 and the first body 4 cannot rotate relatively and be folded.

Since the first body 4 and the second body 5 may be relatively retractable and may rotate and be folded in the extended state, the first body 4 and the second body 5 may be in the retracted state when being mounted, unfolded, and applied at the propellers. In the retracted state, the relative rotation of the first body 4 and the second body 5 may be restricted, and the first connection member 2 may be at least partially overlap with the second connection member 3, which may increase the structural strength of the connection position of the first body 4 and the second body 5. Further, it is ensured that when the propeller protection device 1 is mounted at the rotor UAV, the propeller protection device 1 may not be easily rotated relatively by an external force.

In some embodiments, the rotatable connector 32 may be rotatably connected to the connection body 31 by the first shaft 61 and to the first connection member 2 by the second shaft 62. As such, the second body 5 may rotate relatively and be folded at the first body 4 in the extended state. The first shaft 61 and the second shaft 62 are parallel in the axial direction, and the axial direction may be perpendicular to the direction, along which the guide member 20 of the rotatable connector 32 moves back and forth.

The rotatable connector 32 may be rotatably connected to the first connection member 2 by the second shaft 62. The rotatable connector 32 may not need to be rotatably connected to the connection body 31, for example, the rotatable connector 32 may be fixedly connected to the connection body 31.

The first connection member 2 further includes a chamber 21. The chamber 21 includes the first sidewall 211, the first upper wall 212, and a first lower wall 213. The first upper wall 212 and the first lower wall 213 are arranged one over another. The first upper wall 212 and the lower wall 213 are connected to the first sidewall 211 to form the chamber 21. The first sidewall 211, the first upper wall 212, and the first lower wall 213 may be connected to a front-end surface of the first base 40, that is, the front-end surface of the first base 40 may be considered as a rear wall of the chamber 21.

A front-end surface of the chamber 21 includes an opening, thus, the rotatable connector 32 may move in and out of the chamber 21 from the front-end surface of the chamber 21 when moving. In the extended state, the rotatable connector 32 may extend out of the chamber 21. In the retracted state, the rotatable connector 32 may be accommodated in the chamber 21.

The guide member 20 may be arranged at the first sidewall 211 of the chamber 21. For example, the guide member 20 may include the straight-line slide slot that passes through the first sidewall 211, or may be the straight-line slide slot that does not pass through the first sidewall 211.

Due to a restriction of a slide slot edge of the straight-line slide slot, the second shaft 62 connected to the second lugs 323 cannot be moved out of the straight-line slide slot. The first shaft 61 connected to the first lugs 321 is located outside of the straight-line slide slot. The plate member 321 may move along the straight-line slide slot. On one aspect, the length of the straight-line slide slot may ensure that the first body 4 and the second body 5 may rotate to be folded when the plate member 321 extends out of the chamber 21. On another aspect, the length of the straight-line slide slot may ensure that the plate member 321 may be accommodated in the chamber 21 as much as possible when being retracted, for example, only the portion where the first shaft 61 is located may be outside of the chamber 21, and the second shaft 62 may abut an end of the straight-line slide slot.

The plate member 321 and the first upper wall 212 of the chamber 21 may abut each other when they rotate relative to a certain angle to constraint the rotation angle of the rotatable connector 32 relative to the first connection member 2 in the extended state. In some embodiments, the rotatable angle of the rotatable connector 32 relative to the first connection member 2 may be 90° in the extended state. When the plate member 321 rotates to 90° relative to the first connection member 2, the plate member 321 and the first upper wall 212 of the chamber 21 may abut each other. A stopper may be arranged at the chamber 21 to stop the plate member 321 when the plate member 321 rotates to 90° relative to the first connection member 2. The structure of the stopper is not limited.

The connection body 31 may include an accommodation space to accommodate the first connection member 2 in the retracted state. That is, in the retracted state, the first connection member 2 not only may have an overlapping relationship with the rotatable connector 32 but also have an overlapping relationship with the connection body 31. That is, in the retracted state, the rotatable connector 32 may be accommodated in the first connection member 2, and the first connection member 2 may be accommodated in the accommodation space of the connection body 31 to further improve the strength of the folding portion. In the retracted state, the first connection member 2 may not need to be accommodated in the connection body 31, as long as the first connection member 2 may abut the connection body 31 and cannot rotate relatively.

As shown in FIG. 3 and FIG. 7, the connection body 31 includes a second upper wall 311, a second lower wall 312, and a second sidewall 313 connected between the second upper wall 311 and the second lower wall 312. The second upper wall 311, the second lower wall 312, and the second sidewall 313 enclose to form an accommodation space that can accommodate the first connection member 2. The second upper wall 311 is shorter than the second lower wall 312 to divide the accommodation space into a first space and a second space. The second spacer is closer to the first body 4 than the first space. The first spacer may be formed and enclosed by the second lower wall 312, the second upper wall 311, and the second sidewall 313. The second spacer may be formed and enclosed by the lower wall 312 and the second sidewall 313. The rotatable connector 32 may be rotatably connected to the second sidewall 313 where the first space is. The first connection member 2 may be accommodated in the second space in the retracted state.

The form of the connection body 31 is not limited here. For example, the second upper wall 311 and the second lower wall 312 may have the same length and be arranged symmetrically. When being accommodated in the second space, the first connection member 2 may be enclosed by the second upper wall 311, the second lower wall 312, and the sidewall 313. For another example, the second lower wall 312 may not be arranged, and the second upper wall 311 may be configured to constraint the rotation of the connection body 31.

In the retracted state, the second upper wall 311 may contact the first connection member 2 to cause the connection body 31 and the first connection member 2 to have a tendency to move relatively. The relative rotation may be constraint by the second upper wall 311 abutting the first connection member 2. A stopper may be arranged at the connection body 31 to abut the first connection member 2 to constraint the relative rotation but do not constrain the second upper wall 311.

In some embodiments, the second upper wall 311 may be combined with the first connection member 2 in the retracted state to cause the connection between the second connection member 3 and the first connection member 2 to be smooth to improve the appearance quality of the whole.

In the extended state, when the connection body 31 may rotate relative to the rotatable connector 32, the second upper wall 311 may abut the rotatable connector 32 at a certain rotation angle to constraint the rotatable angle. In some embodiments, the rotatable angle of the connection body 31 relative to the rotatable connector 32 may be 90°.

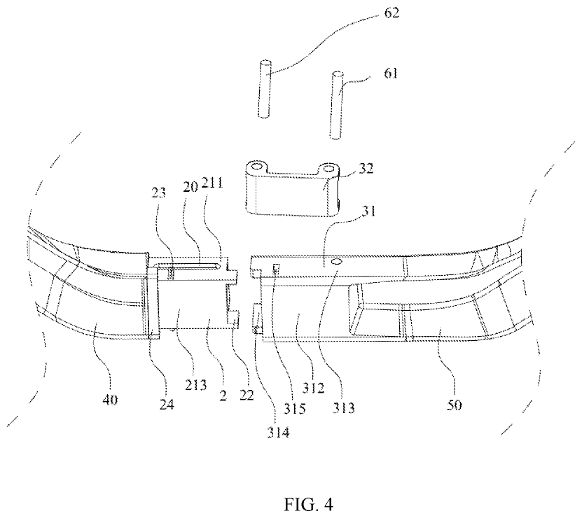

As shown in FIG. 4 and FIG. 7, an end of the first connection member 2 (i.e., a front end of the first connection member 2) close to the second body 5 includes a position limit protrusion 22. In the retracted state, the second lower wall 312 and the first shaft 61 are arranged one over another to clamp the position limit protrusion 22 in the middle.

In other words, the position limit protrusion 22 is arranged at the front end of the first connection member and is located below the rotatable connector 32. In the retracted state, the first connection member 2 may enter the accommodation spacer of the connection body 31. The position limit protrusion 22 may contact the second lower wall 312, and the first shaft 61 may be retracted to the position limit protrusion 22. As such, the position limit protrusion 22 is located between the second lower wall 312 and the first shaft 61 and constraint by the second lower wall 312 and the first shaft 61 to ensure that the connection body 31 and the first connection member 2 cannot rotate.

Arranging the position limit protrusion 22 and constraining the position limit protrusion 22 by the second lower wall 312 and the first shaft 61 may not the only manner to constraint the relative rotation between the connection body 31 and the first connection member 2. For example, the connection body 31 may include upper and lower portions, which may both enclose the first connection member 2. As such, the first connection member 2 may be clamped in the middle by the second upper wall 311 and the second lower wall 312 of the connection body 31 to constraint the relative rotation between the connection body 31 and the first connection member 2.

As shown in FIG. 3, FIG. 4, and FIG. 7, the connection body 31 includes a first position limit member 314 at an end of the connection body 31 (i.e., a front-end surface of the connection body 31) close to the first body 4. The first connection member 2 includes a second position limit member 24 at a position corresponding to the first position limit member 314.

The first position limit member 314 may include a slot opening. The second position limit member 24 may include a protruded edge. The protruded edge may enter the slot opening in the retracted state to limit the position of each other. The shape of the slot opening may match the shape of the protruded edge, and the specific shapes are not limited. The first position limit member 314 and the second position limit member 24 may be interchangeable, that is, the first position limit member 314 may include the protruded edge, and the second position limit member 24 may include the slot opening.

The slot opening configured as the first position limit member 314 may be formed at the second sidewall 313 and/or the end of the second lower wall 312 close to the first body 4. As shown in FIG. 3, the slot opening is formed at the front-end surfaces of the second sidewall 313 and the second lower wall 312. The protruded edge is arranged below the first connection member 2 and located at the intersection of the first connection member 2 and the first base 40. The positions and specific shapes of the slot opening and the protruded edge are not limited here.

In the retracted state, the first position limit member 314 may contact the second position limit member 24 to constraint the relative movement upward and/or downward of the connection body 31 and the first connection member 2. In some embodiments, in the retracted state, the first position limit member 314 may be combined with the second position limit member 24. With the above-described arrangement, the connection position of the first position limit member 314 and the second position limit member 24 may be smooth, and the appearance quality may be improved.

The first connection member 2 may be connected to the middle position of the front-end surface of the first base 40. A size of a longitudinal section of the first connection member 2 may be smaller than a size of a longitudinal section of the first base 40, which forms a step at the connection position of the first connection member 2 and the first base 40. That is, the rear end surface of the first connection member 2 may be narrower than the front-end surface of the first base 40, and the first connection member 2 may be connected to the middle position of the front-end surface of the first base 40. Thus, the step may be formed. The step may be formed at two sides of the connection position of the first connection member 2 and the first base 40. In some other embodiments, when the first connection member 2 does not include the protruded edge that is configured as the second position limit member 24, the step may be formed at the bottom of the connection position of the first connection member 2 and the first base 40. In the retracted state, the connection body 31 may be combined with the step of first connection member 2, thus, the connection may be smooth, and the appearance quality may be improved.

To further improve the stability of the first body 4 and the second body 5 in the retracted state, the connection body 31 and the first connection member 2 may include a snap buckle structure, which snapped tightly with each other in the retracted state.

As shown in FIG. 3, FIG. 12, and FIG. 13, the snap buckle structure includes a snap hole 315 arranged at the connection body 31 or the first connection member 2 and a snap piece 23 arranged at the first connection member 2 or the connection body 31 and cooperating with the snap hole 315 for snap connection. In some embodiments, the sidewall of the connection body 31 includes the snap hole 315. The first sidewall 211 of the first connection member 2 includes a snap piece 23. In the retracted state, the snap piece 23 enters the snap hole 315. Two sides of the snap piece may be curved, when receiving a certain pressure or pulling force, the snap piece 23 may enter and move out of the snap hole 315 smoothly.

The snap buckle structure of the connection body 31 and the first connection member 2 may be replaced by other forms of structures, which is not limited.

In the specification, the terms of first and second are merely used to distinguish one object or operation from another object or operation and do not necessarily require or imply such actual relationship or sequence between these objects or operations. The terms of “include,” “contain,” or any other variants thereof are intended to include non-exclusive inclusion, so that a process, method, article, or device including a series of elements include not only those elements, but also other elements that are not explicitly listed, or include elements inherent to such process, method, article, or device. If there are no more restrictions, the element defined by the sentence “including a . . . ” does not exclude the existence of other same elements in the process, method, article, or device including the element.

The method and device consistent with embodiments of the present disclosure are described in detail above. Specific examples are used in this article to illustrate principles and embodiments of the present disclosure. The description of above embodiments is only used to help understand the method and core idea of the present disclosure. Meanwhile, for those of ordinary skill in the art, according to the idea of the present disclosure, modifications may be made in specific embodiments and application scope. In summary, the content of this specification should not be understood as a limitation of the disclosure.

What is claimed is:

1. A foldable and retractable mechanism comprising:
a first body including a first connection member;
a second body configured to rotate relative to the first body and including a second connection member;
wherein the first connection member and the second connection member are assembled in movable manner and configured to be in:
a retracted state, in which the first connection member and the second connection member at least partially overlap with each other and constraint relative rotation of the first body and the second body; and
an extended state, in which the first connection member is away from the second connection member, and the second body is rotatable and capable of being folded over the first body.

2. The mechanism of claim 1, wherein:
the second body further includes a base; and
the second connection member includes:
a connection body fixed at the base; and
a rotatable connector rotatably connected to the connection body, the rotatable connector being movably connected to the first connection member to allow the second connection member to move relative to the first connection member.

3. The mechanism of claim 2, wherein:
the rotatable connector is rotatably connected to the connection body through a first shaft and rotatably connected to the first connection member through a second shaft; and
the rotatable connector is configured to, in the extended state, rotate relative to the connection body through the first shaft and rotate relative to the first connection member through the second shaft.

4. The mechanism of claim 3, wherein the rotatable connector includes:
a plate member; and
a protrusion member arranged at the plate member and connected to the first shaft and the second shaft to cause axes of the first shaft and the second shaft to be above the plate member.

5. The mechanism of claim 4, wherein the protrusion member includes:
at least two first lugs arranged at the plate member and connected to the first shaft; and
at least two second lugs arranged at the plate member and connected to the second shaft.

6. The mechanism of claim 2, wherein the connection body includes an accommodation space to accommodate the first connection member in the retracted state.

7. The mechanism of claim 6, wherein:
the connection body includes an upper wall, a lower wall longer than the upper wall, and a sidewall connected between the upper wall and the lower wall, the upper wall, the lower wall, and the sidewall enclosing to form the accommodation space;
the accommodation spacer includes:
a first space enclosed and formed by a portion of the lower wall, the upper wall, and a portion of the sidewall; and
a second spacer closer to the first body than the first space, the second space being enclosed and formed by another portion of the lower wall and another portion of the sidewall; and
the rotatable connector is rotatably connected to the another portion of the sidewall, and the first connection member is accommodated in the second space in the retracted state.

8. The mechanism of claim 2, wherein:
the connection body includes an upper wall; and
the upper wall contacts the first connection member in the retracted state.

9. The mechanism of claim 2, wherein:
the connection body includes a lower wall;
a position limit protrusion is arranged at an end of the first connection member that is close to the second body;
the rotatable connector is rotatably connected to the connection body through a shaft; and
in the retracted state, the lower wall and the shaft are arranged one over another to clamp the position limit protrusion in the middle.

10. The mechanism of claim 2, wherein:
the connection body includes a first position limit member at an end of the connection body close to the first body;
the first connection member includes a second position limit member at a position of the first connection member corresponding to the first position limit member; and
in the retracted state, the first position limit member contacts the second position limit member.

11. The mechanism of claim 10, wherein:
the first position limit member includes a slot opening; and
the second position limit member includes a protruded edge configured to enter the slot opening in the retracted state.

12. The mechanism of claim 11, wherein:
the connection body includes a lower wall and a sidewall connected to each other; and
the slot opening is formed at an end of the sidewall and/or the lower wall close to the first body.

13. The mechanism of claim 2, wherein the connection body and the first connection member include a snap buckle structure configured to snap in the retracted state.

14. The mechanism of claim 13, wherein the snap buckle structure includes:
a snap hole arranged at one of the connection body and the first connection member; and
a snap piece arranged at another one of the connection body and the first connection member, and configured to cooperate with and be snapped to the snap hole.

15. The mechanism of claim 2, wherein in the extended state, a rotatable angle of the connection body relative to the rotatable connector is 90°.

16. The mechanism of claim 2, wherein in the extended state, a rotatable angle of the rotatable connector relative to the first connection member is 90°.

17. The mechanism of claim 2, wherein:
the first connection member further includes:
a chamber including a sidewall; and
a guide member arranged at the sidewall of the chamber and configured to guide the rotatable connector to move back and forth along the guide member; and
the rotatable connector is configured to extend outside the chamber in the extended state and be accommodated in the chamber in the retracted state.

18. The mechanism of claim 17, wherein:
the guide member includes a straight-line slide slot; or
the first body includes a base, the first connection member being formed integrally at the base.

19. The mechanism of claim 18, wherein:
the first connection is connected to the base at a middle position of a front-end surface of the base;
a size of a longitudinal cross-section of the first connection member is smaller than a size of a longitudinal cross-section of the base; and
a step is formed at a connection portion of the first connection member and the base.

20. A propeller protection device comprising a foldable and retractable mechanism including:
a first propeller protection cover including a first connection member;
a second propeller protection cover configured to rotate relative to the first body and including a second connection member;
wherein the first connection member and the second connection member are assembled in movable manner and configured to be in:
a retracted state, in which the first connection member and the second connection member at least partially overlap with each other and constraint relative rotation of the first propeller protection cover and the second propeller protection cover; and
an extended state, in which the first connection member is away from the second connection member, and the second propeller protection cover is rotatable and capable of being folded over the first propeller protection cover.
